(19) United States
(12) Patent Application Publication
(10) Pub. No.: US 2023/0014392 A1
(43) Pub. Date: Jan. 19, 2023

(54) METHOD AND SYSTEM FOR PRIVACY-PRESERVING PORTFOLIO PRICING

(71) Applicant: JPMorgan Chase Bank, N.A., New York, NY (US)

(72) Inventors: Gilad ASHAROV, Givaat Shmuel (IL); Tucker Richard BALCH, Suwanee, GA (US); Antigoni Ourania POLYCHRONIADOU, New York, NY (US)

(73) Assignee: JPMorgan Chase Bank, N.A., New York, NY (US)

(21) Appl. No.: 17/660,157

(22) Filed: Apr. 21, 2022

(30) Foreign Application Priority Data
Jul. 1, 2021 (GR) 20210100450

(51) Int. Cl. G06Q 40/06; G06Q 40/04; G06Q 30/02

(52) U.S. Cl. CPC G06Q 40/06; G06Q 40/04; G06Q 30/0206

(57) ABSTRACT

A method for assessing a value of an investment portfolio is provided. The method includes: receiving first information that relates to the investment portfolio from an investor; receiving second information that relates to a pricing model that is used by a financial institution for pricing investment assets; calculating metrics that relate to an estimated value of the investment portfolio based on the first information and the second information; and determining an assessed value of the investment portfolio based on the calculated metrics. The method may be implemented by using a secure multiparty computation technique by which the investor and the financial institution provide sensitive information as inputs to an algorithm without revealing the sensitive information to each other, thereby preserving the privacy of both parties.

### CROSS-REFERENCE TO RELATED APPLICATIONS

This application claims priority from Greek Patent Application No. 20210100450, filed in the Greek Patent Office on Jul. 1, 2021, which is hereby incorporated by reference in its entirety.

### BACKGROUND

### 1. Field of the Disclosure

This technology generally relates to methods and systems for preserving privacy with respect to pricing a portfolio, and more particularly, to methods and systems for assessing a price of a portfolio of a group of financial assets by using secure computation technology to preserve privacy with respect to sensitive information.

### 2. Background Information

A portfolio sale is a sale of a large group of financial assets in a single transaction. Consider a case in which a client holds a portfolio that it wishes to sell, which may also include some assets that take relatively long to liquidate. As a result, selling the portfolio in the market might take a long time, and prices might change during the sale. Selling the portfolio as a whole to some other financial institution (e.g., a bank) is an immediate, atomic operation in which the client sells the entire portfolio to a bank and improves its liquidity immediately by turning the portfolio into cash. The bank, in return, can “internalize” offers for the assets in the portfolio at a price slightly lower than the market price, therefore potentially gaining in such a transaction when selling its content later in the market.

Pricing a portfolio is not a simple procedure. When a bank offers a price, it takes into account a wide range of parameters, i.e., which assets the portfolio contains, what their current price is in the market, what is the expected return of the portfolio, its volatility (i.e., correlation between the different assets), time to liquidate, idiosyncratic risk, and more. Conventionally, a bank makes an offer on a portfolio after weighing all those parameters, aligned with concepts from modern portfolio theory.

When making an offer, a bank also has to take into account the potential effect of buying a portfolio to its own portfolio and possessions. Buying a portfolio changes a bank's current inventory. For example, a bank might be very interested in buying a portfolio in cases where the bank is currently short of 15,000 shares of some asset, and that portfolio contains 16,000 shares of that same asset. This action of buying such a portfolio is known as “internalization.” In that case, the bank may choose to make an attractive offer. Conversely, if buying the portfolio might increase the overall volatility of the joint portfolios of the bank and its client, then the bank may more likely offer a price that is less attractive to the client.

In many cases, a bank has to price a portfolio without knowing its content. This is known as “blind” pricing. A conventional business model relies on the fact that this blind portfolio pricing is a repeated game between the client and the bank. Since a typical portfolio often contains some asset that is hard to liquidate, and since such transactions are confidential, the client sends only summarized information about its portfolio to the bank—such as sector breakdown (e.g., energy, financial, technology, etc.), breakdown by market and country, etc. The bank typically has to make an offer given only this summarized information.

This state of affairs is problematic. The client does not provide fully disclosed information about the portfolio that it is willing to sell. The bank, therefore, cannot give a real estimation of the price of the portfolio. As the bank cannot identify the actual content of the portfolio, it cannot recognize individual assets it may have been interested in obtaining and the offering price may not be as attractive as it could have been. The client might then not agree to the offer, and transactions that are beneficial to both parties can be missed.

Accordingly, there is a need for a methodology for assessing a price of a portfolio of a group of financial assets by using secure computation technology to preserve privacy with respect to sensitive information.

### SUMMARY

The present disclosure, through one or more of its various aspects, embodiments, and/or specific features or sub-components, provides, inter alia, various systems, servers, devices, methods, media, programs, and platforms for assessing a price of a portfolio of a group of financial assets by using secure computation technology to preserve privacy with respect to sensitive information.

According to an aspect of the present disclosure, a method for assessing a value of an investment portfolio is provided. The method is implemented by at least one processor. The method includes: receiving, by the at least one processor from an investor, first information that relates to the investment portfolio; receiving, by the at least one processor from a financial institution, second information that relates to a pricing model; calculating, by the at least one processor, at least one metric that relates to an estimated value of the investment portfolio based on the first information and the second information; and determining, by the at least one processor, an assessed value of the investment portfolio based on the calculated at least one metric.

The calculating of the at least one metric may include using a secure multiparty computation algorithm to which each of the first information and the second information are provided as inputs.

The at least one metric may include at least one from among a first metric that relates to a total size of the investment portfolio, a second metric that relates to a total market impact of the investment portfolio, and a third metric that relates to a total volatility of the investment portfolio.

The total size of the investment portfolio may be calculated as a summation of products of the numbers of shares of individual securities in the investment portfolio and the corresponding market prices of those individual securities.

The method may further include: receiving, from the financial institution, a plurality of individual market impact values that respectively correspond to the individual securities included in the investment portfolio; calculating, based on the total size of the investment portfolio, a plurality of weights that respectively correspond to the individual securities; and calculating the total market impact of the investment portfolio as a summation of products of the respective weights and the corresponding individual market impact values for the individual securities.

The method may further include: determining, for each respective pair of individual securities included in the investment portfolio, a corresponding covariance value; and calculating the total volatility of the investment portfolio as a function of the respective weights of the individual securities included in the investment portfolio and the determined covariance values.

The method may further include: receiving, from the financial institution, third information that relates to a portfolio of the financial institution; and calculating a volatility of a joint portfolio as a function of the total size of the investment portfolio, a total size of a portfolio of the financial institution, a number of shares and a current market price of each individual security included in the investment portfolio, a number of shares and a current market price of each individual security included in the portfolio of the financial institution, and the determined covariance values.

The method may further include: after the assessed value of the investment portfolio has been determined, receiving, from the financial institution, an offer to purchase the investment portfolio; transmitting, to the investor, the received offer; and when the received offer is accepted by the investor, transmitting, to the financial institution, third information that relates to identifying each individual security included in the investment portfolio and information that indicates a respective number of shares of each identified individual security included in the investment portfolio.

According to another exemplary embodiment, a computing apparatus for assessing a value of an investment portfolio is provided. The computing apparatus includes a processor, a memory, and a communication interface coupled to each of the processor and the memory. The processor is configured to: receive, from an investor via the communication interface, first information that relates to the investment portfolio; receive, from a financial institution via the communication interface, second information that relates to a pricing model; calculate at least one metric that relates to an estimated value of the investment portfolio based on the first information and the second information; and determine an assessed value of the investment portfolio based on the calculated at least one metric.

The processor may be further configured to calculate the at least one metric by using a secure multiparty computation algorithm to which each of the first information and the second information are provided as inputs.

The at least one metric may include at least one from among a first metric that relates to a total size of the investment portfolio, a second metric that relates to a total market impact of the investment portfolio, and a third metric that relates to a total volatility of the investment portfolio.

The total size of the investment portfolio may be calculated as a summation of products of respective numbers of shares of individual securities included in the investment portfolio and corresponding market prices of the individual securities.

The processor may be further configured to: receive, from the financial institution via the communication interface, a plurality of individual market impact values that respectively correspond to the individual securities included in the investment portfolio; calculate, based on the total size of the investment portfolio, a plurality of weights that respectively correspond to the individual securities; and calculate the total market impact of the investment portfolio as a summation of products of the respective weights and the corresponding individual market impact values for the individual securities.

The processor may be further configured to: determine, for each respective pair of individual securities included in the investment portfolio, a corresponding covariance value; and calculate the total volatility of the investment portfolio as a function of the respective weights of the individual securities included in the investment portfolio and the determined covariance values.

The processor may be further configured to: receive, from the financial institution via the communication interface, third information that relates to a portfolio of the financial institution; and calculate a volatility of a joint portfolio as a function of the total size of the investment portfolio, a total size of a portfolio of the financial institution, a number of shares and a current market price of each individual security included in the investment portfolio, a number of shares and a current market price of each individual security included in the portfolio of the financial institution, and the determined covariance values.

The processor may be further configured to: after the assessed value of the investment portfolio has been determined, receive, from the financial institution via the communication interface, an offer to purchase the investment portfolio; transmit, to the investor via the communication interface, the received offer; and when the received offer is accepted by the investor, transmit, to the financial institution via the communication interface, third information that relates to identifying each individual security included in the investment portfolio and information that indicates a respective number of shares of each identified individual security included in the investment portfolio.

According to yet another aspect of the present disclosure, a non-transitory computer readable storage medium storing instructions for assessing a value of an investment portfolio is provided. The storage medium includes executable code which, when executed by at least one processor, causes the at least one processor to: receive, from an investor, first information that relates to the investment portfolio; receive, from a financial institution, second information that relates to a pricing model; calculate at least one metric that relates to an estimated value of the investment portfolio based on the first information and the second information; and determine an assessed value of the investment portfolio based on the calculated at least one metric.

When executed by the at least one processor, the executable code may further cause the at least one processor to calculate the at least one metric by using a secure multiparty computation algorithm to which each of the first information and the second information are provided as inputs.

The at least one metric may include at least one from among a first metric that relates to a total size of the investment portfolio, a second metric that relates to a total market impact of the investment portfolio, and a third metric that relates to a total volatility of the investment portfolio.

When executed by the at least one processor, the executable code may further cause the at least one processor to: after the assessed value of the investment portfolio has been determined, receive, from the financial institution, an offer to purchase the investment portfolio; transmit, to the investor, the received offer; and when the received offer is accepted by the investor, transmit, to the financial institution, third information that relates to identifying each individual security included in the investment portfolio and information that indicates a respective number of shares of each identified individual security included in the investment portfolio.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for assessing a price of a portfolio of a group of financial assets by using secure computation technology to preserve privacy with respect to sensitive information.

FIG. 4 is a flowchart of an exemplary process for implementing a method for assessing a price of a portfolio of a group of financial assets by using secure computation technology to preserve privacy with respect to sensitive information.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

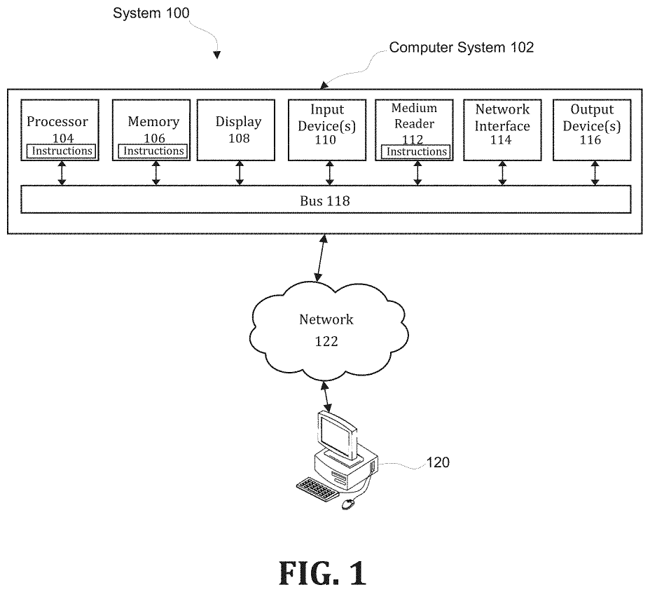

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environments. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (A SIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field-programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read-only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

As described herein, various embodiments provide optimized methods and systems for assessing a price of a portfolio of a group of financial assets by using secure computation technology to preserve privacy with respect to sensitive information.

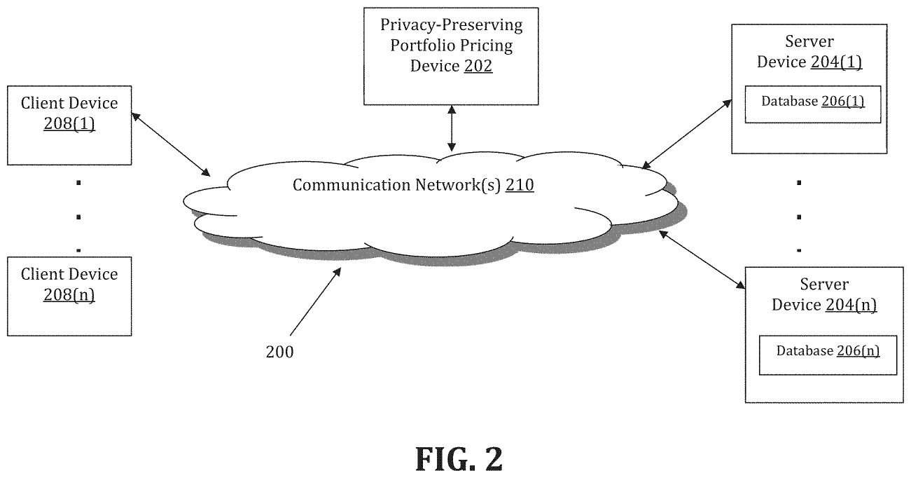

Referring to FIG. 2, a schematic of an exemplary network environment 200 for implementing a method for assessing a price of a portfolio of a group of financial assets by using secure computation technology to preserve privacy with respect to sensitive information is illustrated. In an exemplary embodiment, the method is executable on any networked computer platform, such as, for example, a personal computer (PC).

The method for assessing a price of a portfolio of a group of financial assets by using secure computation technology to preserve privacy with respect to sensitive information may be implemented by a Privacy-Preserving Portfolio Pricing (PPPP) device 202. The PPPP device 202 may be the same or similar to the computer system 102 as described with respect to FIG. 1. The PPPP device 202 may store one or more applications that can include executable instructions that, when executed by the PPPP device 202, cause the PPPP device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the PPPP device 202 itself, may be located in virtual server(s) running in a cloud-based computing environment rather than being tied to one or more specific physical network computing devices. Also, the application(s) may be running in one or more virtual machines (VMs) executing on the PPPP device 202. Additionally, in one or more embodiments of this technology, virtual machine(s) running on the PPPP device 202 may be managed or supervised by a hypervisor.

In the network environment 200 of FIG. 2, the PPPP device 202 is coupled to a plurality of server devices 204(1)-204(n) that hosts a plurality of databases 206(1)-206(n), and also to a plurality of client devices 208(1)-208(n) via communication network(s) 210. A communication interface of the PPPP device 202, such as the network interface 114 of the computer system 102 of FIG. 1, operatively couples and communicates between the PPPP device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the PPPP device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable mediums, and PPPP devices that efficiently implement a method for assessing a price of a portfolio of a group of financial assets by using secure computation technology to preserve privacy with respect to sensitive information.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The PPPP device 202 may be a standalone device or integrated with one or more other devices or apparatuses, such as one or more of the server devices 204(1)-204(n), for example. In one particular example, the PPPP device 202 may include or be hosted by one of the server devices 204(1)-204(n), and other arrangements are also possible. Moreover, one or more of the devices of the PPPP device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the PPPP device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) host the databases 206(1)-206(n) that are configured to store market data and historical trading activity data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(l)-204(n) may operate as a plurality of network computing devices within a cluster architecture, a peer-to-peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the PPPP device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the PPPP device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the PPPP device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the PPPP device 202, the server devices 204(1)-204(n), or the client devices 208(1)-208(n), for example, may be configured to operate as virtual instances on the same physical machine. In other words, one or more of the PPPP device 202, the server devices 204(1)-204(n), or the client devices 208(1)-208(n) may operate on the same physical device rather than as separate devices communicating through communication network(s) 210. Additionally, there may be more or fewer PPPP devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, PDNs, the Internet, intranets, and combinations thereof.

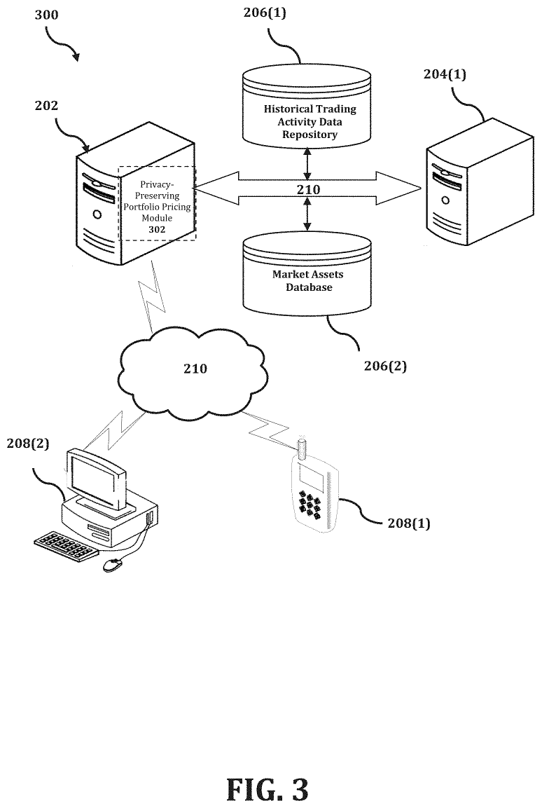

The PPPP device 202 is described and shown in FIG. 3 as including a privacy-preserving portfolio pricing module 302, although it may include other rules, policies, modules, databases, or applications, for example. As will be described below, the privacy-preserving portfolio pricing module 302 is configured to implement a method for assessing a price of a portfolio of a group of financial assets by using secure computation technology to preserve privacy with respect to sensitive information in an automated, efficient, scalable, and reliable manner.

An exemplary process 300 for implementing a method for assessing a price of a portfolio of a group of financial assets by using secure computation technology to preserve privacy with respect to sensitive information by utilizing the network environment of FIG. 2 is shown as being executed in FIG. 3. Specifically, a first client device 208(1) and a second client device 208(2) are illustrated as being in communication with PPPP device 202. In this regard, the first client device 208(1) and the second client device 208(2) may be “clients” of the PPPP device 202 and are described herein as such. Nevertheless, it is to be known and understood that the first client device 208(1) and/or the second client device 208(2) need not necessarily be “clients” of the PPPP device 202, or any entity described in association therewith herein. Any additional or alternative relationship may exist between either or both of the first client device 208(1) and the second client device 208(2) and the PPPP device 202, or no relationship may exist.

Further, PPPP device 202 is illustrated as being able to access a historical trading activity data repository 206(1) and a market assets database 206(2). The privacy-preserving portfolio pricing module 302 may be configured to access these databases for implementing a method for assessing a price of a portfolio of a group of financial assets by using secure computation technology to preserve privacy with respect to sensitive information.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s)210, which may comprise plural networks as described above. For example, in an exemplary embodiment, either or both of the first client device 208(1) and the second client device 208(2) may communicate with the PPPP device 202 via broadband or cellular communication. Of course, these embodiments are merely exemplary and are not limiting or exhaustive.

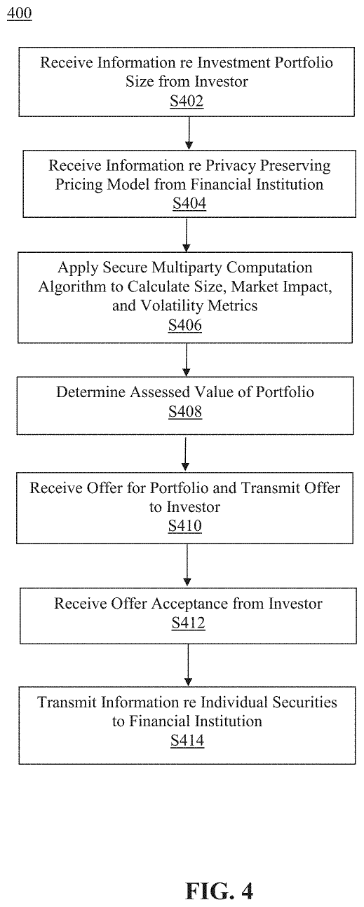

Upon being started, the privacy-preserving portfolio pricing module 302 executes a process to assessing a price of a portfolio of a group of financial assets by using secure computation technology to preserve privacy with respect to sensitive information. An exemplary process for assessing a price of a portfolio of a group of financial assets by using secure computation technology to preserve privacy with respect to sensitive information is generally indicated at flowchart 400 in FIG. 4.

In the flowchart 400 of FIG. 4, at step S402, the privacy-preserving portfolio pricing module 302 receives first information that relates to the investment portfolio from an investor that is interested in selling the entire investment portfolio in a single transaction. In an exemplary embodiment, the first information includes information that summarizes the contents of the portfolio and also includes an estimate of the total size of the portfolio based on the current market prices for each individual security included in the portfolio. In another exemplary embodiment, if the investor trusts that the sensitive information regarding the specific details of the investment portfolio will remain confidential, the first information may include information that identifies each individual security included in the portfolio and a respective number of shares of each individual security included in the portfolio.

At step S404, the privacy-preserving portfolio pricing module 302 receives second information that relates to a pricing model to be used by a financial institution for determining a price to be offered for the investment portfolio. In an exemplary embodiment, the second information may include a set of market impact values that are individually applicable to respective stocks and/or securities. These values may be determined by the financial institution. In an exemplary embodiment, the second information may also include information that relates to a portfolio of the financial institution. In this aspect, the financial institution may use information about its own portfolio in formulating the pricing model.

At step S406, the privacy-preserving portfolio pricing module 302 calculates various metrics to be used for determining an offer price for the investment portfolio. In an exemplary embodiment, the metrics may include any one or more of a first metric that relates to a total size of the investment portfolio, a second metric that relates to a total market impact of the investment portfolio, and a third metric that relates to a total volatility of the investment portfolio and/or a joint volatility of a combined portfolio that accounts for how the purchase of the investment portfolio would affect the existing portfolio of the financial institution.

In an exemplary embodiment, the privacy-preserving pricing module 302 uses a secure multiparty computation algorithm to calculate the metrics. In this manner, the investor is not required to provide complete information about the specific contents of the investment portfolio, and the financial institution is not required to reveal the totality of its pricing model for determining an offer price for such a portfolio, and the metrics are still able to be calculated based on the inputs provided in steps S402 and S404.

At step S408, the privacy-preserving portfolio pricing module 302 determines an assessed value of the investment portfolio based on the calculated metrics. Then, at step S410, the financial institution uses the metrics and the assessed value to decide whether to make an offer for the portfolio and an amount to be offered, and when such an offer is received, the offer is forwarded to the investor.

At step S412, when the investor accepts the offer, the acceptance of the offer is received by the privacy-preserving portfolio pricing module 302. Finally, after acceptance of the offer, at step S414, the privacy-preserving portfolio pricing module 302 is authorized to reveal the specific details of the investment portfolio to the purchaser, i.e., information that identifies each individual security and the corresponding number of shares of each individual security that is included in the portfolio.

A new mechanism for pricing portfolios is disclosed herein. In an exemplary embodiment, based on advances in cryptography, secure multiparty computation techniques are adopted to allow a more accurate and truthful pricing mechanism despite the fact that a client may not be willing to provide complete information on its own portfolio and a bank may not be willing to provide complete information on its pricing model.

Secure multiparty computation provides a general solution for the following problem: mutually distrustful parties wish to compute some joint function on their inputs without revealing them to one another. Feasibility results show that essentially any task can be computed using secure computation. In particular, any two-input function can be converted into an interactive protocol in which each party holds one of the two inputs, communicates with the other party, and the interactive does not reveal any information about the inputs, other than what is revealed from obtaining the output.

In an exemplary embodiment, secure computation is applied to the problem of portfolio pricing. The input of the client is its own portfolio, and the input of the bank is its private pricing model. The parties jointly compute the offer while the bank does not reveal its pricing model and the client does not reveal its portfolio. This allows a more accurate pricing mechanism, and in cases where the bank can internalize the portfolio by finding matches with its own portfolio, the bank can make a very attractive offer, for the benefit of both the client and the bank. Similar to the common practice today, the portfolio of the client becomes visible to the bank only after making the offer and after the client accepts.

Since the actual pricing method of each bank is different and is generally considered confidential, a private computation of several common metrics which are taken into account when pricing portfolios is disclosed herein, including protocols for the following tasks.

First, a relatively simple pricing mechanism is disclosed in which the bank gives independent prices to each assets and disregards the correlation between the different assets that the client is willing to sell. The price per asset is some private computation of the bank as a function of the number of shares. This allows the bank to also take its own portfolio into account and allows internalization. The final price is then a weighted sum of all prices per asset.

Second, a protocol for computing different metrics when combining the portfolio of the bank and the client is described. This protocol is a secure protocol which reveals only the client's portfolio total size (i.e., if sold now in the market according to the market price, what is the total price of the portfolio?), the client's portfolio expected market impact, and the volatility of the joint portfolios of the bank and the client. Those are given as output to the bank, and the bank weighs those parameters together to make an offer using its private model.

For ease of exposition and accessibility, a garbled circuit cryptographic technique is used for computing all measures, although optimizations to running times can be made using more sophisticated and specifically tailored protocols. Importantly, in an exemplary embodiment based on the garbled circuit cryptographic technique, pricing generally takes few minutes, and therefore there may be no need for optimizing the protocols to the levels of seconds.

In summary, one or more exemplary embodiments provide: 1) investigation in the area of privacy-preserving portfolio pricing, allowing the client and the bank to jointly compute metrics enabling more accurate pricing while preserving the privacy of both sides, 2) adaptation of secure computation protocols for computing these metrics, and a description of methods for computing several metrics, and 3) a demonstration of the practicality of those protocols via experimental results.

Secure Multi-Party Computation (MPC) allows a set of mutually distrustful parties to compute a function jointly over their inputs while maintaining the privacy of the inputs and ensuring the correctness of the outputs. Assuming the existence of some external trusted party, a trust-based solution can be given where the trusted party simply receives inputs from all the parties, computes the function and returns the result. Secure MPC allows to eliminate the need for such an external trusted party. Previous results have shown that any computation can be emulated by a secure protocol, and the protocol in a sense replaces the trusted party.

More concretely, the present disclosure focuses on secure two-party computation. Consider the two parties P0 and P1 that hold private inputs x0, x1, respectively, and wish to compute some arbitrary function (y₀,y₁)=ƒ (x₀, x₁), where the output of P i is yᵢ for i ∈{0,1}. MPC enables the parties to compute the function using an interactive protocol, where each party P i learns exactly yᵢ, and nothing else. In this solution, the main technical contribution is to define ƒ appropriately such that it captures the privacy guarantees of the disclosed mechanisms.

Security of MPC: The security of the protocol should be preserved even in the presence of some adversarial entity that corrupts some of the participating parties, combines their transcripts and coordinates their behaviors. Several different types of adversaries have been studied, where the complexity and the efficiency of the protocols depend on the level of security. In one example, a semi-honest adversary (also known as “honest-but-curious” or “passive”), follows the protocol specification but may attempt to learn secret information about the private information of the honest parties from the messages it receives. In comparison, a malicious adversary (also known as “active”) may, in addition, deviate from the protocol specification and follow any arbitrary behavior. To keep the exposition clear, the semi-honest adversary is the focus in the present disclosure; namely, it is assumed that the bank and the client function as semi-honest adversaries and thus do not alter the code that the designer of the protocol provides them.

Security definition: In an exemplary embodiment, a standard notion of security of stand-alone secure two-party computation with security against semi-honest behavior is used. Before providing a formal definition of security, the following provides some intuition. Let ƒ: {0,1}⁺×{0,1}⁺→{0,1}⁺×{0,1}⁺ be a functionality, and let ƒ₀ (x,y) be the first element of ƒ (x,y), where ƒ₁ (x,y) is the second element, and so forth. For the present disclosure, there is a focus on deterministic functionalities. In particular, the protocol π consists of a sequence of algorithms (i.e., “next message function”) that specify what message P messages have been received so far.

Correctness: In an exemplary embodiment, a protocol is deemed as being “correct” if the output of the parties in the protocol execution according to the protocol is the same as the function ƒ. That is, let (z,)=output^{Π}(x,y) be the output of the parties when both parties run the protocol T with inputs (x,y). The protocol is (perfectly) correct if for every x, it holds that outputnx^{Π})=ƒ (x,y).

Privacy: The only information that is allowed to be learned during the protocol execution is the output. To formalize privacy, it is required that all messages that a party receives during the protocol execution can be simulated (i.e., generated) by using just its input and output. This means, intuitively, that no other information is learned from those messages, as they can be generated from the input and output.

To formalize this, let view^{Π}0 (x,) denote the view of party P0 in the execution of the protocol where P0 has input x and P 1 has input y, where the view consists of (x, r, m1, . . . , mt), where x is the input, r is P0's internal random coins and m1, . . . , t are the messages it has received during the interaction; and viewr^{Π}1(x,) is defined analogously. Moreover, let ƒi (x,) denote the i th element of ƒ (x,y); that is, if (z,w)=ƒ (x,y), then ƒ₀ (x,y)=z and ƒ₁ (x,y)=w. It may be said that a function μ(·) is negligible if for all polynomials p(·) there exists n0 such that for every n≥n0 it holds that p(n)≤1/p (n). As a result, the following definition may be provided:

Definition 2.1 (Privacy). For a deterministic two-party function ƒ we say that II privately computes ƒ if there exists a pair of probabilistic polynomial time algorithms, denoted S₀, S₁, and for every distinguisher D there exists a negligible function μ(·) such that for every x, y and i ∈{0,1}:

$$\vert Pr [ D ( {S}_{i} ( x , {f}_{i} ( x , y ) ) , x , y ) = 1 ] - Pr [ D ( {view}_{i}^{Π} ( x , y ) , x , y ) = 1 ] \vert \leq \frac{1}{p ( n )}$$

Garbled Circuits: The main cryptographic technique that is relied on in the present disclosure is known as the garbled circuit. The following is a high level description of the protocol.

The MPC protocol is a general protocol for secure two-party computation and allows a computation of any polynomial-time function. The protocol views such a function as a Boolean circuit C, that is, for every pair of inputs x,y it holds that C(x,y)=ƒ (x,y) where x,y are encoded as bits. In an exemplary embodiment, it is assumed that x,y are taken from the range [B], and each is encoded using log |B| bits. The circuit C consists of input wires, which are associated with the inputs x and y; intermediate wires, which are outputs of intermediate gates; and output wires, which are associated with the output value C(x,y). When evaluating the circuit with inputs x and y, values are assigned to the input wires according to binary representation of x and y. Then, the circuit can be evaluated on a gate-by-gate basis. Specifically, upon assigning values α, b ∈ {0,1} on the input wires of some gate g, the gate can be evaluated, and the value g(α, b) can be assigned on its output wire, where g(α, b) is computed according to the truth table of that gate (e.g., Boolean OR, Boolean AND or Boolean XOR). After evaluating all gates, the output of the evaluation is the values on the output wires.

Garbled circuit: This protocol is a method for making the previously described evaluation of the circuit private. The parties will be able to evaluate the circuit without either party learning the values on the input wires that are associated with the input of the other party. Moreover, each evaluation will be done without learning the values on the intermediate wires, as those values might “leak” some information about the input of the other party that cannot necessarily be learned from the output. This is achieved by letting one party (i.e., “the garbler”) to first encrypt the circuit, and then sending this encrypted circuit to the other party (i.e., “the evaluator”). The evaluator can evaluate the circuit C(x,·) exactly once, on one input of its choice—y, to obtain (x,y).

Specifically, for every wire w in the circuit C, the garbler chooses two random keys k_{w}⁰ and k w¹ of size λ, where λ is the security parameter. In an exemplary embodiment, the value of λ is usually 128, 192 or 256 bits. The key k_{w}⁰ represents the value 0 on the wire, while k_{w}¹ represents the value 1 on the wire. The basic idea is that the evaluator will receive exactly one of these two keys, according to the true value of the wire when evaluating C(x,y). Importantly, once the evaluator receives the key k_{w}α for some α ∈ {0,1}, this key does not give any information about k_{w}^{1-α}, as the two k_{w}⁰ and k_{w}¹ are independent and uniformly distributed. Moreover, the key does not give any information about the value α, i.e., the true value on the wire.

Assuming that the evaluator receives, in a secure way, all keys of all the wires that correspond to x and y (note that this may be achieved without learning any information about x and without leaking any information about y, as further described below), a mechanism that will enable it to securely compute gates is needed. That is, let g be a gate with inputs w 1, w 2 and output wire w 3. Given k w^{α} and k_{w}^{b} for some specific values α, b ∈(0,1), a mechanism that will allow the evaluator to learn the key k₃^{g(α,b)} but without learning any information about k₃^{1-9 (α,b)} is needed.

In an exemplary embodiment, such a mechanism may be implemented as follows. The garbler encrypts {E k₁(E k₂β(k₃^{g(α,β)}))}α, ∈{0,1}, i.e., the garbler encrypts the key associated with g(α,β) using the keys that are associated with α and β, for the four possible values of α,β∈{0,1}. See Example 3.1 below for a demonstration of a garbled table for the Boolean AND function. The garbler sends a permutation of these four values to the evaluator. In the evaluation phase, the evaluator obtains the keys k₁^{a} and k₂^{b} for some specific values α, b ∈{0,1}, but not k₁^{1-a} and k₂^{1-b}. Thus, it is possible to decrypt E k₁(E k₂^{β}(k₃^{g(α,β)})) and obtain k₃^{(α,β)}, but not any one of the other three possible encryptions, as one of the keys will be missing. Moreover, the evaluator cannot learn any information about k₃^{1-g(α,β)}, as this value is encrypted using a key that is unknown to the evaluator. This method enables the evaluator, who did not know the values α and b, to obtain a key corresponding to the output value of the gate g(α, b), without learning the real values α, b and g (α, b). Moreover, as the evaluator learns the key k₃^{g(α,β)}, the evaluator can proceed and evaluate gates for which w₃ is an input wire. The evaluator can proceed in a similar manner until eventually reaching the output wires.

Learning the output: As for the output wires, the garbler does not have to generate two random keys. Instead, the garbler can just decrypt the values 0 or 1, or some fixed encoding of these values with length A. As a result, when the evaluator evaluates the garbled circuit, the evaluator can learn the actual binary output, and then decode the binary output back to a value in [B]. Upon receiving the output, the evaluator can send it also to the garbler.

| Input wire w₁ | Input wire w₂ | Output wire w₃ | Garbled Output |
|---|---|---|---|
| k₁⁰ | k₂⁰ | k₃⁰ | Eₖ_{₁}_{⁰} (Eₖ_{₂}_{⁰} (k₃⁰)) |
| k₁⁰ | k₂¹ | k₃⁰ | Eₖ_{₁}_{⁰} (Eₖ_{₂}_{¹} (k₃⁰)) |
| k₁¹ | k₂⁰ | k₃⁰ | Eₖ_{₁}_{¹} (Eₖ_{₂}_{⁰} (k₃⁰)) |
| k₁¹ | k₂¹ | k₃¹ | Eₖ_{₁}_{¹} (Eₖ_{₂}_{¹} (k₃¹)) |

Example 3.1. A garbled table for the Boolean AND function, for two wires w₁, w₂ and output wire w₃. The garbled randomly permute this table and sends only the “Garbled Output” column to the evaluator. When evaluating the circuit, the evaluator will obtain keys k₁^{α} and k₂^{b} where α, b ∈{0,1} are the values on the wires w₁ and w₂, respectively. These two keys will enable it to decrypt k₃^{AND(α,b)}, i.e., the value on the wire w₃.

Obtaining the input keys: To this point, a description is provided for how the garbler can create a garbled circuit, and how the evaluator can evaluate the circuit without learning anything on the intermediate wires once the evaluator obtains the keys of the input wires that correspond to x and y. In order to complete the description of the protocol, it is left to show how the evaluator can obtain these keys.

First, for the input of the garbler, x of log |B| bits, the garbler knows the values on the input wires associated with its input, and therefore the garbler can send the keys that correspond to these values. As mentioned above in paragraph [0098], the evaluator does not learn any information about the input x as these keys are distributed uniformly.

For the input of the evaluator y with respect to a value of t=log |B| bits (y₁, . . . ,ₜ), the situation is more delicate, for the following reasons. Let w₁, . . . ,ₜ be the labels of these wires in the circuit C. The garbler knows the pair of keys (k₁⁰, k₁¹), . . . , (kₜ⁰, kₜ¹) while the evaluator has to obtain (k₁^{y1}, . . . , kₜ^{yt}) without learning any information about(k₁^{1-yl}, . . . , kₜ^{1-yt}). On the one hand, the garbler cannot simply send the two pairs of keys to the evaluator, because then the evaluator would be able to evaluate the circuit on any input z of its choice to learn C(x, z), and thus learn significant information about x. On the other hand, the evaluator cannot indicate to the garbler which inputs it is interested in, as this would completely reveal y. In order to solve these contradictory requirements, the two parties use another building block that is known as “oblivious transfer” (or “OT”).

Oblivious transfer: In 1-out-of-2 oblivious transfers, the sender holds as input two messages m0 and m1, and the receiver inputs a choice bit b ∈ {0,1}. The output of the receiver is the message m b without learning anything about m1-b and without the sender learning anything about b. That is, the parties compute the function:

fOT((m₀,m₁),b)=(∈,m_{b}),

where ∈ denotes the empty string. In this case, the sender will be the garbler and the receiver will be the evaluator. Moreover, the garbler and the evaluator will engage in t invocations of OT, one for every input-bit of the evaluator. In the i^{th} invocation, the garbler inputs a pair of keys (kᵢ⁰, kᵢ⁰) while the evaluator inputs its i^{th} input bit yᵢ. The evaluator will learn kᵢ^{y}. There are many known protocols for oblivious transfer, and for simplicity, in an exemplary embodiment, the following protocol is described: the sender generates two random messages x₀ and x₁, and generates a public-key/secret-key pair (pk, sk). The sender then sends x₀, x₁ and pk to the receiver. The receiver chooses a random key k, and sends k′=x_{b} ⊕Encₚₖ(k) to the sender. The sender then computes y₀=m₀⊕Decₛₖ (k⊕x₀), y₁=m₁⊕Decₛₖ (k⊕x₁), and sends y_{0,1} to the receiver. The receiver outputs y_{b} ⊕k=m_{b}. Correctness holds since:

y_{b}⊕k=m_{b}⊕Decₛₖ(k′⊕x_{b})⊕k

=m_{b}⊕Decₛₖ(x_{b}⊕Encₚₖ(k)⊕x_{b})⊕k

=m_{b}⊕k⊕k=m_{b}

Intuitively, privacy of sender holds, since m1-b is encrypted using key Decₛₖ (x₀⊕x₁ (Encₚₖ (k)). While the receiver knows x₀ ⊕x₁ E Encₚₖ (k), the receiver does not have access to s k and therefore the receiver's pre-image looks uniform, which in turn completely hides m1-b. Privacy of the receiver holds since k is completely random, and thus Encₚₖ(k) completely hides x_{b}.

In an exemplary embodiment, the following protocol is an instantiation of the above-described protocol. Theorem: Any two-party function ƒ can be privately computed using the above protocol in the presence of a semi-honest adversary.

Optimizations. First, oblivious transfers are expensive operations because they rely on public-key operations, which are generally more expensive than private-key operations, and therefore it is desirable to reduce their amount. Using oblivious transfer extensions, one can perform just a few oblivious transfers, essentially the same amount as the security parameter, and then obtain as many oblivious transfers as it wishes using only private-key operations, which are much more efficient. This reduces the amount of public-key operations to be as low as the security parameter, regardless the size of the input. Another optimization reduces the size of the garbled gates: instead of having four rows per gate, one can send just two rows, namely, only two encryptions. Moreover, one can obtain XOR gates “for free,” i.e., at virtually no cost, and therefore, to the extent that XOR gates can be used instead of garbled gates, there may be no need to send a garbled gate at all.

Privacy-Preserving Portfolio Pricing. In an exemplary embodiment, a general problem definition is as follows: A client holds a portfolio, and the bank should assess the value of this portfolio. The goal is to price the portfolio while the bank does not learn the exact possessions that the client is interested in, and the client does not learn information about the pricing model of the bank. The pricing model of the bank can also depend on the bank's private inventory. The following notations are provided for reference: [symbol]
[symbol] ={symb₁, . . . , symbₘ} denotes the universe of all possible possessions (e.g., all stocks listed in NYSE).
B: bounds the number of possible number of shares that the client might hold.
D: bounds the price that the bank offers for the client for a given symbol. The price is given in basis points (bips), i.e., one basis point equals to 1/100th of 1%.
A portfolio is a list [symbol] =(num₁, . . . , numₘ), where each numᵢ ∈[B] denotes the number of shares and the side for possession symb₁.

In an exemplary embodiment, a general statement of a privacy-preserving portfolio pricing problem is the following: the client holds L=(num₁, . . . , numₘ). The bank holds some private function: [B]→[D] that evaluates the portfolio and outputs the price that the bank is willing to pay. Note that since the bank's pricing mechanism g is general, the bank can encode its own portfolio into the pricing mechanism and then compute the price of the client portfolio as a function of its own portfolio without revealing it, as the pricing mechanism g is private. Moreover, the bank can also take into account correlations between different assets.

To implement this, the parties can evaluate a universal circuit U(L, g)=(L). For that, the parties need to have some upper bound on the size of g when represented as circuit. The parties can then evaluate this universal circuit using the garbled circuit protocol as described above.

While the above describes a general problem statement, an implementation in the most general form would be prohibitively expensive. Thus, this is provided as a theoretical concept in order to demonstrate that the concept of privacy-preserving portfolio pricing is possible. The following description refers to classes of models for the bank that are more limited and show their practicality.

Each asset is considered independently. The following is a description of specific pricing models and a showing of their practicality. First, attention is restricted to a class of functions in which each asset is considered separately, and the bank does not consider the correlation between the different assets in the portfolio. That is, the pricing mechanism g′can be described as follows:

$${g}^{′} ( ℒ ) = {\sum }_{i = 1}^{m} {f}_{{symb}_{i}} ( {num}_{i} ) ,$$

where ƒsymb₁: [B]→{0,1}⁺, i.e., the function ƒ maps the number of shares that the client has to a price, and the final price is just a sum of all prices. The final price is then a conversion of the price to bips, which can be done in clear. Each function ƒsymbᵢ can take into account the current stock price and the number of shares that the bank has of the same asset.

Example: step functions. To make things more concrete, it is assumed that each function ƒsymbᵢ has two different steps: for each symbol, the bank might have different values for the first X shares, a second value for the next shares up to some limit, Y, and then a third value for number of shares that exceeds Y.

The justification for this is that if the symbᵢ is in the inventory of the bank, then the bank might give the symbol X a special price for the first X shares, as it is interested to reduce its exposure to price changes for that stock. For the next Y shares, the bank might give a price that is proportional to the current stock price, however, the bank may not be interested to have high exposure to the stock, and therefore when the number of shares exceeds some value, Y, the bank may give a higher price which is not as attractive.

Formally, the following assessment function is provided for a given symbol symbᵢ where (P 1, P2, P3) are three private prices of the bank, X,Y are two private thresholds, and num is the number of shares that the client wishes to sell:

$${f}_{symb} ( num ) = \{ \begin{matrix}num \cdot {P}_{1} & if num \leq X \\ {Z}_{1} + ( num - X ) \cdot {P}_{2} & if X < num \leq Y \\ {Z}_{2} + ( num - Y ) \cdot {P}_{3} & if num > Y\end{matrix} , \\ where {Z}_{1} = X \cdot {P}_{1} and {Z}_{2} = X \cdot {P}_{1} + ( Y - X ) \cdot {P}_{2} . \qquad ( 1 )$$

An implementation of this function as a circuit and a showing of running times are provided below.

Common metrics for pricing a portfolio. In an exemplary embodiment, it is assumed that the bank and the client will jointly compute these metrics, and that the pricing model of the bank is a function of these metrics.

For a given portfolio L=(num₁, . . . , numₘ) which denotes the number of shares per possession, over some universe U=(symb₁, . . . , symbₙ), the following metrics are defined as follows:

Total size: The total size is essentially the current value in the market. For each symbol symbi, let currentStockPricei denote the current stock price at the market. In an exemplary embodiment, the total size is then defined as:

$$TotalSize = {\sum }_{i = 1}^{n} {num}_{i} \cdot {currentStockPrice}_{i} .$$

Market impact: Market impact is the effect that a market participant has when it buys or sell an asset, i.e., how the price might move (downward) against the seller when selling the entire asset. There are several statistical measures for computing market impact of each asset, and each bank might choose its own method. However, after defining the value R i for each asset symb₁, the market impact of the portfolio is just a weighted sum of all assets. In an exemplary embodiment, for each asset symb₁, the corresponding weight w i may be defined as:

$${w}_{i} = \frac{{currentStockPrice}_{i} \cdot {num}_{i}}{TotalSize} .$$

Then, market impact is defined as:

$$MarketImpact = {\sum }_{i = 1}^{n} {w}_{i} \cdot {R}_{i} . \qquad ( 2 )$$

Volatility. For each stock one can compute its expected return given the history of the portfolio. Moreover, one can compute the standard deviation of the stock's past return to estimate its risk, i.e., how widely the value of the stock increases and declines. When holding several financial assets, the expected return of the entire portfolio is the weighted average of the expected returns. However, to estimate the risk, one has also to calculate how correlated the stocks are, and if they tend to move up and down together. This leads to the definition of volatility: a statistical measure of dispersion of returns.

For computing the volatility of the portfolio, one should first compute for every pair of assets symb₁, symbj the covariance of the two assets. Given the adjusted close price over some interval (e.g., last month, 3 months, etc.), one can compute sequences of changes in each stock, denoted as X i and X j, respectively. The covariance of the two stocks is defined as c o v_{i,j}=E[(Xi-E[Xi](Xj-E[Xj])]. In an exemplary embodiment, given a portfolio with weights (w₁, . . . ,ₙ), the volatility σ may be computed as:

$${σ}^{2} = {\sum }_{i = 1}^{n} {\sum }_{j = 1}^{n} {w}_{i} \cdot {w}_{j} \cdot {cov}_{i , j} .$$

Computing the metrics privately: In an exemplary embodiment, the client and the bank engage in a secure two party computation where the bank inputs its portfolio L=(num₁, side₁, . . . , numₙ, sideₙ), in which the bank learns:

1. The total size of the client's portfolio. Since this information can be computed solely by the client, it is assumed that the client computes this total size metric honestly in the clear and sends the total size metric to the bank. To reduce the amount of trust required, this may also be computed as part of the secure protocol, eliminating the client's ability to use different values of L inside the secure protocol and in computing the total size.

2. The parties compute the expected market impact. For this, the bank inputs its (perhaps secret) values R₁, . . . , Rₙ and the parties jointly compute the market impact in accordance with Equation (2) above (see paragraph [0120]).

3. The bank and the client compute the volatility of the joint portfolio of the bank and the client. For this, the bank must also input its own portfolio to the secure computation. A description of how to compute this volatility metric is provided below.

At the end of the secure computation, the bank learns those three values, and the bank's pricing model takes them into account for determining the final offer price.

In an exemplary embodiment, to be more concrete, let (α₁, . . . , αₙ) be the number of shares the client wants to sell. Let (b₁, . . . , bₙ) be the possessions of the bank. Once the client provides its total size, which is denoted below as TotalSizeC, the expected market impact is:

$$MarketImpact = \frac{1}{TotalSizeC} \cdot {\sum }_{i = 1}^{n} {R}_{i} \cdot {a}_{i} \cdot {currentStockPrice}_{i} .$$

To make the circuit smaller, the bank can divide by TotalSizeC after computing in secure computation the term Σ_{i=1 to n}Ri·αi· currentStockPricei, in the clear. To compute the volatility of the joint portfolio of the bank and client, the bank inputs its portfolio (b1, . . . , bn) and also locally computes its total size TotalSizeB=Σ_{i=1 to n}bi· currentStockPricei. The parties jointly compute:

$${\sum }_{i = 1}^{n} {\sum }_{j = 1}^{n} {a}_{i} \cdot {b}_{j} \cdot ( {currentStockPrice}_{i} \cdot {currentStockPrice}_{j} ) \cdot {σ}_{i , j} ,$$

then, the bank can divide by TotalSizeC·TotalSizeB to obtain the volatility of the joint portfolio.

Example. Assume that U consists of the following stocks: (TLT, SPY, DAL, UAL). There is a negative correlation between the volatility of TLT and that of all other stocks in this list. Taking historical data since Jan. 1, 2020, the covariance matrix 1s given below in Table 1. In Table 2 below, the changes in the volatility of the joint portfolio compared to the volatility of the portfolio of the bank are shown. In an exemplary embodiment, according to the protocols as described above, the bank cannot see the client's portfolio, its size or its volatility. Yet, as the output of the computation, the bank can see the volatility of the joint portfolio, and as a result, the bank can see how buying the client portfolio affects its own portfolio. In this example, buying the portfolio reduces the total volatility of the bank, because the volatility of TLT is negatively correlated with respect to the volatility of the other stocks, and therefore, the bank can give an attractive offer.

TABLE 1
Covariance matrix for (TLT, SPY, DAL, UAL). TLT
is negatively correlated to the other stocks.

| | TLT | SPY | DAL | UAL |
|---|---|---|---|---|
| TLT | 0.000151654 | −9.53638E−05 | −0.000106427 | −0.000115843 |
| SPY | −9.53638E−05 | 0.000340195 | 0.000467204 | 0.00055536 |
| DAL | −0.000106427 | 0.000467204 | 0.001986076 | 0.002364827 |
| UAL | −0.000115843 | 0.00055536 | 0.002364827 | 0.003316028 |

TABLE 2
Demonstrating joining the bank's and client's portfolios. The bank will obtain the volatility of the joint portfolio, but
not the volatility of the portfolio of the client. It computes how the volatility changes when buying the client's portfolio.

| | Current | Client's Portfolio | | | Bank's Portfolio | | | Joint Portfolio | | |
|---|---|---|---|---|---|---|---|---|---|---|
| Symbol | Stock Price | Num | Size | Weights | Num | Size | Weights | Num | Size | Weights |
| TLT | 143.29 | 1000 | 143290 | 1 | 0 | 0 | 0 | 1000 | 143290 | 0.215276213 |
| SPY | 420.86 | 0 | 0 | 0 | 1000 | 420860 | 0.805751264 | 1000 | 420860 | 0.632292183 |
| DAL | 45.77 | 0 | 0 | 0 | 1000 | 43770 | 0.087628274 | 1000 | 45770 | 0.068763991 |
| UAL | 55.69 | 0 | 0 | 0 | 1000 | 55090 | 0.106620463 | 1000 | 55690 | 0.033667613 |

| | | | |
|---|---|---|---|
| Total size | 143290 | 522320 | 665610 |
| Volatility | 0.01231479 | 0.021895185 | 0.01639978 |

Implementation and evaluation. In an exemplary embodiment, the above-described protocol for privacy-preserving portfolio pricing may be implemented by using the C++ version of the Secure Computation API library (SCAPI), including the garbled circuits protocol with free-XOR technique, half-gates, and OT extensions. To implement the protocol, the computations described above are converted to circuits.

Step functions: In an exemplary embodiment, a circuit is built for the pricing model described as in Equation 1 above (see paragraph [0116]). The following gates are used as building blocks: a comparison (<), a multiplexer (MUX), a negation (for which the negation of b is denoted as b′), a full adder, subtractor and a multiplication gate. In order to compute this function, the following operations are performed: 1. Compute two bits: b₁=(shares<X), b₂=(shares<Y). 2. There are three price ranges for the function, as indicated in Equation 1 above. Thus, compute three bits x₁=b1, b2=(b₂ Λb₁′) and b₃=(b₁′, Λb₂′). Only one of those bits will be activated, indicating in which range num is. 3. Use a MUX that according to (x₁, x₂, x₃) selects (0, Y), respectively. Let the selected value be W. 4. Likewise, use a MUX that according to (x₁, x₂, x₃) selects (P₁, P₂, P₃). Define this value by L. 5. Precompute (0, Z1, Z2); these will be part of the input of the bank to the computation. One value will be selected according to (x₁, x₂, x₃) using a MUX, and denote the selected value as Z. 6. Output Z+L·(num−W).

Then, to obtain the final offer price, full adders are used for adding all results to obtain one final value. This can be done in a tree fashion. This is the output of the computation.

In Table 3 below, a number of gates and running times are reported as a function of the universe size, demonstrating that the number of gates increases linearly with the number of symbols in U. The running time is also reported for an average of 5 executions. In all executions, |B|=|D|=2²⁸ is used. The two parties are implemented as AWS m5.large machines, with 8 GB of RAM and are connected via 10 Gbps network. Also included in the report is the ratio of XOR gates, which are gates that are not part of the computation. The total communication is roughly the number of non-XOR gates times the size of two ciphertexts, each is 128 bits (8 bytes). That is, for |U|, the total communication is 84 MB.

Computing joint metrics: In an exemplary embodiment, an implementation is provided for the computation of a metric privately. For a circuit in which the bank inputs its portfolio, parameters for computing the market impact and for computing the client's portfolio size is included in the implementation, and the results are reported in Table 4 below. The expensive part of the computation is the computation of the volatility—since the computation of the volatility is quadratic in the number of symbols, processing roughly 33 symbols has comparable running times to processing 1000 symbols of step functions. To mitigate this, one approach is to first break down the computation to different baskets, i.e., divide the universe into distinct small baskets where there is no strong correlation between different baskets. Another possibility is to run first a secure set intersection protocol and avoid taking into account symbols that are not part of the computation.

TABLE 3
Number of gates, number of non-XOR gates and running times for
the privacy-preserving step-function based pricing mechanism.

| Num of | Num of | Total Num | Running time |
|---|---|---|---|
| Symbols | non-XOR gates | of gates | (sec) (±sdv) |
| 50 | 261,828 | 974,540 | 0.88 (±0.011) |
| 100 | 523,432 | 1,947,960 | 1.77 (±0.016) |
| 500 | 2,616,106 | 9,734,530 | 8.98 (±0.032) |
| 1000 | 5,232,108 | 19,468,540 | 18.39 (±0.05) |

TABLE 4
Number of gates, number of non-XOR gates and
running times for computing common metrics -
size, market impact and joint volatility.

| Num of | Num of | Total Num | Running time |
|---|---|---|---|
| Symbols | non-XOR gates | of gates | (sec) (±sdv) |
| 5 | 1,185,403 | 4,530,403 | 2.065 (±0.014) |
| 10 | 4,618,139 | 17,643,907 | 8.2478 (±0.034) |
| 20 | 18,226,705 | 69,625,736 | 33.27 (±0.0182) |

In an exemplary embodiment, a setting in which the client and the bank engage in secure computation in order to evaluate metrics of the portfolio in order to estimate the value of the portfolio may be studied. Further, an evaluation of metrics of the joint portfolio of the client and the bank may be studied for facilitating a computation of the effect of buying the portfolio. Secure computation can be useful and powerful for solving this problem.

In an exemplary embodiment, there are several other interesting metrics that can be computed and are useful for pricing portfolios, such as notions of time to liquidate tail, idiosyncratic risk, and more. A further direction is to use different cryptographic protocols for computing the common metrics. The computation may be optimized, and different types of protocols may be used, such as, for example, the use of fully homomorphic encryption or protocols that are based on arithmetic sharing or garbling.

Accordingly, with this technology, an optimized process for implementing methods and systems for assessing a price of a portfolio of a group of financial assets by using secure computation technology to preserve privacy with respect to sensitive information is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory.

Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for assessing a value of an investment portfolio, the method being implemented by at least one processor, the method comprising:
receiving, by the at least one processor from an investor, first information that relates to the investment portfolio;
receiving, by the at least one processor from a financial institution, second information that relates to a pricing model;
calculating, by the at least one processor, at least one metric that relates to αₙ estimated value of the investment portfolio based on the first information and the second information; and
determining, by the at least one processor, an assessed value of the investment portfolio based on the calculated at least one metric.

2. The method of claim 1, wherein the calculating of the at least one metric comprises using a secure multiparty computation algorithm to which each of the first information and the second information are provided as inputs.

3. The method of claim 1, wherein the at least one metric includes at least one from among a first metric that relates to a total size of the investment portfolio, a second metric that relates to a total market impact of the investment portfolio, and a third metric that relates to a total volatility of the investment portfolio.

4. The method of claim 3, wherein the total size of the investment portfolio is calculated as a summation of products of respective numbers of shares of individual securities included in the investment portfolio and corresponding market prices of the individual securities.

5. The method of claim 4, further comprising:
receiving, from the financial institution, a plurality of individual market impact values that respectively correspond to the individual securities included in the investment portfolio;
calculating, based on the total size of the investment portfolio, a plurality of weights that respectively correspond to the individual securities; and
calculating the total market impact of the investment portfolio as a summation of products of the respective weights and the corresponding individual market impact values for the individual securities.

6. The method of claim 5, further comprising:
determining, for each respective pair of individual securities included in the investment portfolio, a corresponding covariance value; and
calculating the total volatility of the investment portfolio as a function of the respective weights of the individual securities included in the investment portfolio and the determined covariance values.

7. The method of claim 6, further comprising:
receiving, from the financial institution, third information that relates to a portfolio of the financial institution; and
calculating a volatility of a joint portfolio as a function of the total size of the investment portfolio, a total size of a portfolio of the financial institution, a number of shares and a current market price of each individual security included in the investment portfolio, a number of shares and a current market price of each individual security included in the portfolio of the financial institution, and the determined covariance values.

8. The method of claim 1, further comprising:
after the assessed value of the investment portfolio has been determined, receiving, from the financial institution, an offer to purchase the investment portfolio;
transmitting, to the investor, the received offer; and
when the received offer is accepted by the investor, transmitting, to the financial institution, third information that relates to identifying each individual security included in the investment portfolio and information that indicates a respective number of shares of each identified individual security included in the investment portfolio.

9. A computing apparatus for assessing a value of an investment portfolio, the computing apparatus comprising:
a processor;
a memory; and
a communication interface coupled to each of the processor and the memory,
wherein the processor is configured to:
receive, from an investor via the communication interface, first information that relates to the investment portfolio;
receive, from a financial institution via the communication interface, second information that relates to a pricing model;
calculate at least one metric that relates to an estimated value of the investment portfolio based on the first information and the second information; and
determine an assessed value of the investment portfolio based on the calculated at least one metric.

10. The computing apparatus of claim 9, wherein the processor is further configured to calculate the at least one metric by using a secure multiparty computation algorithm to which each of the first information and the second information are provided as inputs.

11. The computing apparatus of claim 9, wherein the at least one metric includes at least one from among a first metric that relates to a total size of the investment portfolio, a second metric that relates to a total market impact of the investment portfolio, and a third metric that relates to a total volatility of the investment portfolio.

12. The computing apparatus of claim 11, wherein the total size of the investment portfolio is calculated as a summation of products of respective numbers of shares of individual securities included in the investment portfolio and corresponding market prices of the individual securities.

13. The computing apparatus of claim 12, wherein the processor is further configured to:
receive, from the financial institution via the communication interface, a plurality of individual market impact values that respectively correspond to the individual securities included in the investment portfolio;
calculate, based on the total size of the investment portfolio, a plurality of weights that respectively correspond to the individual securities; and
calculate the total market impact of the investment portfolio as a summation of products of the respective weights and the corresponding individual market impact values for the individual securities.

14. The computing apparatus of claim 13, wherein the processor is further configured to:
determine, for each respective pair of individual securities included in the investment portfolio, a corresponding covariance value; and
calculate the total volatility of the investment portfolio as a function of the respective weights of the individual securities included in the investment portfolio and the determined covariance values.

15. The computing apparatus of claim 14, wherein the processor is further configured to:
receive, from the financial institution via the communication interface, third information that relates to a portfolio of the financial institution; and
calculate a volatility of a joint portfolio as a function of the total size of the investment portfolio, a total size of a portfolio of the financial institution, a number of shares and a current market price of each individual security included in the investment portfolio, a number of shares and a current market price of each individual security included in the portfolio of the financial institution, and the determined covariance values.

16. The computing apparatus of claim 9, wherein the processor is further configured to:
after the assessed value of the investment portfolio has been determined, receive, from the financial institution via the communication interface, an offer to purchase the investment portfolio;
transmit, to the investor via the communication interface, the received offer; and
when the received offer is accepted by the investor, transmit, to the financial institution via the communication interface, third information that relates to identifying each individual security included in the investment portfolio and information that indicates a respective number of shares of each identified individual security included in the investment portfolio.

17. A non-transitory computer readable storage medium storing instructions for assessing a value of an investment portfolio, the storage medium comprising executable code which, when executed by at least one processor, causes the at least one processor to:
receive, from an investor, first information that relates to the investment portfolio;
receive, from a financial institution, second information that relates to a pricing model;
calculate at least one metric that relates to an estimated value of the investment portfolio based on the first information and the second information; and
determine an assessed value of the investment portfolio based on the calculated at least one metric.

18. The storage medium of claim 17, wherein when executed by the at least one processor, the executable code further causes the at least one processor to calculate the at least one metric by using a secure multiparty computation algorithm to which each of the first information and the second information are provided as inputs.

19. The storage medium of claim 17, wherein the at least one metric includes at least one from among a first metric that relates to a total size of the investment portfolio, a second metric that relates to a total market impact of the investment portfolio, and a third metric that relates to a total volatility of the investment portfolio.

20. The storage medium of claim 17, wherein when executed by the at least one processor, the executable code further causes the at least one processor to:
after the assessed value of the investment portfolio has been determined, receive, from the financial institution, an offer to purchase the investment portfolio;
transmit, to the investor, the received offer; and
when the received offer is accepted by the investor, transmit, to the financial institution, third information that relates to identifying each individual security included in the investment portfolio and information that indicates a respective number of shares of each identified individual security included in the investment portfolio.
